(19) United States
(12) Patent Application Publication
(10) Pub. No.: US 2009/0169752 A1
(43) Pub. Date: Jul. 2, 2009

(54) Method for Improving Resistance to CMAS Infiltration

(76) Inventors: Ming Fu, Hamilton, OH (US); Ramgopal Darolia, West Chester, OH (US); Mark Gorman, West Chester, OH (US); Bangalore Aswatha Nagaraj, West Chester, OH (US)

Correspondence Address: GENERAL ELECTRIC COMPANY, GE AVIATION, ONE NEUMANN WAY MD H17, CINCINNATI, OH, 45215, US

(21) Appl. No.: 11/964,960

(22) Filed: Dec. 27, 2007

(51) Int. Cl. B05D 3/00; B05D 7/00

(52) U.S. Cl. 427/299; 427/419.2

(57) ABSTRACT

Methods for providing improved resistance to CMAS infiltration for hot section components of a gas turbine engine. Exemplary methods include coating a substrate with a thermal barrier coating system by overlying a bond coated substrate with an inner thermal barrier layer comprised of a thermal barrier material such as yttria-stabilized zirconia. A top layer, including a rare-earth aluminate, is deposited so as to overlie at least a portion of the inner layer. Deposition processes and coating thicknesses may be tailored to the type of component to be coated.

### FIELD OF THE INVENTION

The present invention is directed to a multilayer coating system for hot section turbine components, and more specifically to a multilayer coating that includes rare earth elements and coated articles

### BACKGROUND OF THE INVENTION

Calcium-magnesium-aluminum-silicate (CMAS) infiltration is a phenomenon that is linked to thermal barrier coating (TBC) spallation in hot section turbine components.

Thermal barrier coatings are utilized on hot section engine components including combustor section and turbine section components to protect the underlying base materials from high temperatures as a result of the flow of hot gases of combustion through the turbine. These hot gases of combustion can be above the melting point of the base materials, which typically are superalloy materials, being based on iron, nickel, cobalt and combinations thereof. The thermal barrier coatings provide passive protection from overheating, and are used in conjunction with cooling airflow that provides active cooling protection.

Under service conditions, these thermal barrier-coated hot section engine components can be susceptible to various modes of damage, including erosion, oxidation and corrosion from exposure to the gaseous products of combustion, foreign object damage and attack from environmental contaminants. Environmental contaminants that can be present in the air include sand, dirt, volcanic ash, sulfur in the form of sulfur dioxide, fly ash, particles of cement, runway dust, and other pollutants that may be expelled into the atmosphere, such as metallic particulates, such as magnesium, calcium, aluminum, silicon, chromium, nickel, iron, barium, titanium, alkali metals and compounds thereof, including oxides, carbonates, phosphates, salts and mixtures thereof. These environmental contaminants are in addition to the corrosive and oxidative contaminants that result from the combustion of fuel. These contaminants can adhere to the surfaces of the hot section components, which are typically thermal barrier coated.

At the operating temperature of the engine, these contaminants can form contaminant compositions on the thermal barrier coatings. These contaminant compositions typically include calcia, magnesia, alumina, silica (CMAS), and their deposits are referred to as CMAS. At temperatures above about 2240° F., these CMAS compositions may become liquid and infiltrate into the TBC. This infiltration by the liquid CMAS destroys the compliance of the TBC, leading to premature spallation of the TBC. In addition to the compliant loss, deleterious chemical reactions with yttria and zirconia within the TBC, as well as with the thermally grown oxide at the bond coating/TBC interface, occur and result in a degradation of the coating system.

The spallation due to CMAS infiltration has become a greater problem in jet engines as their operating temperatures have increased to improve efficiency, as well as in engines operating in the Middle East and in coastal regions. High concentrations of fine sand and dust in the ambient air can accelerate CMAS degradation. A typical composition of CMAS is, for example, 35 mole % CaO, 10 mol % MgO, 7 mol % Al₂O₃, 48 mol % SiO₂, 3 mol % Fe₂O₃ and 1.5 mol % NiO. And of course, spallation of the TBC due to exposure to CMAS at elevated temperature only sets the stage for more serious problems. Continued operation of the engine once the passive thermal barrier protection has been lost leads to rapid oxidation of the base metal superalloy protective coating and the ultimate failure of the component by burn through or cracking. In fact, such significant distress has been observed in both military and commercial engines.

Various solutions to the problem of CMAS degradation have been attempted. However, as operating temperatures of engines have gradually trended higher, ever more effective treatments are required. What is needed is a TBC system that is resistant to CMAS penetration at elevated temperatures.

### SUMMARY OF THE INVENTION

Exemplary embodiments disclosed herein provide methods for improving resistance to CMAS infiltration of a thermal barrier coating system. An exemplary method includes providing a substrate having at least one surface, depositing a bond coat on the substrate surface, and optionally, subjecting the bond coat to suitable conditions to form a thermally grown oxide layer on the bond coat. The method further includes depositing a thermal barrier coating inner layer overlying the bond coat, wherein the inner layer includes a thermal barrier coating material including at least one of zirconia and hafnia, and depositing a top layer overlying at least a portion of the inner layer, wherein the top layer includes a rare earth aluminate-containing material.

An exemplary method includes depositing an thermal barrier coating inner layer onto a bond coated substrate for use in a hot section of a gas turbine engine and depositing a top layer overlying at least a portion of the inner layer, wherein the top layer includes a rare earth aluminate-containing material.

### BRIEF DESCRIPTION OF THE DRAWINGS

FIG. 1 depicts a schematic cross-sectional view of an as-coated article embodying an exemplary coating system.

FIG. 2 is a schematic representation of a Re₂O₃—Al₂O₃ phase diagram illustrating exemplary rare earth aluminate compounds.

FIG. 3 is a micrograph showing post-reaction microstructure of a rare earth aluminate sample after exposure to CMAS at 2500° F. (1371° C.) for one hour.

FIG. 4 is a flowchart of an exemplary coating process.

FIG. 5 depicts differential thermal analysis (DTA) curves from a test sample.

### DETAILED DESCRIPTION OF THE INVENTION

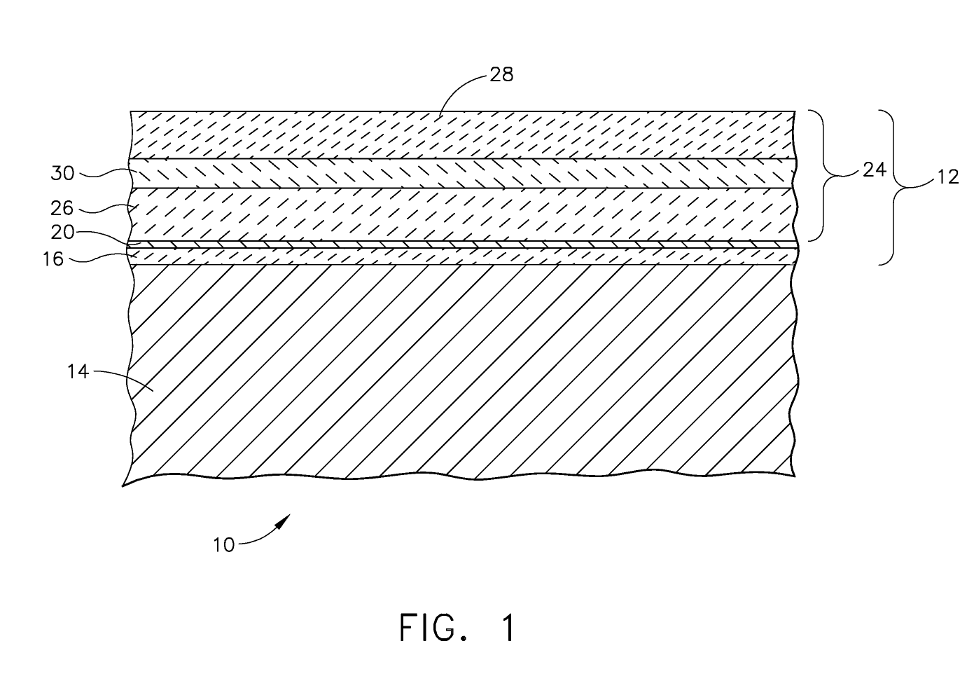

Referring now to FIG. 1, exemplary embodiments include a coated article 10 including a multi-layer thermal barrier coating system 12 that is resistant to CMAS infiltration, in particular for application to a substrate 14 of hot section components of gas turbine engines. The substrate 14 typically is a metallic substrate in need of thermal protection. Exemplary substrates include nickel base superalloy substrates.

In an exemplary embodiment, the coating system 12 includes a bond coat layer 16 overlying and in contact with at least a portion of the substrate 14. The bond coat layer 16 may be an overlay coating, such as MCrAlX (where M=Ni, Co, Fe, and their combinations, and X═Y, Hf, Zr, Re, Si etc. and their combinations), although it may also be a diffusion aluminide, referred to herein as a coating or glaze, such as a simple aluminide (NiAl) or a platinum modified aluminide ((Ni,Pt)Al). The bond coat layer 16 may promote the formation of a thin, tightly adherent aluminum oxide layer 20, commonly known as a thermally grown oxide (TGO). In an exemplary embodiment, a thermal barrier coating (TBC) 24 overlies the bond coat layer 16. The TGO acts as an adhesion layer between the TBC 24 and the bond coat layer 16. The bond coat layer also provides oxidation protection to the underlying substrate. In an exemplary embodiment, the TBC includes at least a TBC inner layer 26 and a rare earth aluminate-containing TBC top layer 28 overlying at least a portion the TBC inner layer 26. In an exemplary embodiment, the inner layer 26 overlies and is in contact with the TGO layer 20, or the bond coat layer 16 in the absence of the TGO layer 20. Optionally, the TBC may include a transitional layer 30 generally disposed between the inner layer 26 and the top layer 28. Reference to “transitional layer 30” is intended to encompass one or more transitional sub-layers forming a compositional gradient between inner layer 26 and top layer 28. In the absence of the optional transitional layer 30, the top layer 28 generally overlies and is in contact with the inner layer 26.

In an exemplary embodiment, the TBC inner layer 26 may be a thermal barrier coating material, such as yttria-stabilized zirconia (YSZ). An exemplary yttria-stabilized zirconia includes zirconia stabilized with 7 wt % yttria, as is referred to a 7YSZ. In an exemplary embodiment, the TBC inner layer 26 may comprises zirconia stabilized with about 4-9 weight % yttria. Alternately, the TBC inner layer 26 may comprise hafnia, or combination of hafnia and zirconia stabilized with about 4-9 weight % yttria. It is envisioned that other compatible thermal barrier coating compositions and coating systems may be utilized in the exemplary embodiments disclosed herein. For example, the TBC may be a low thermal conductivity thermal barrier coating as described for example in U.S. Pat. No. 6,558,814. It is further envisioned that the TBC inner layer 26 may comprise a plurality of sub-layers able to provide the desired thermal barrier protection to the underlying substrate.

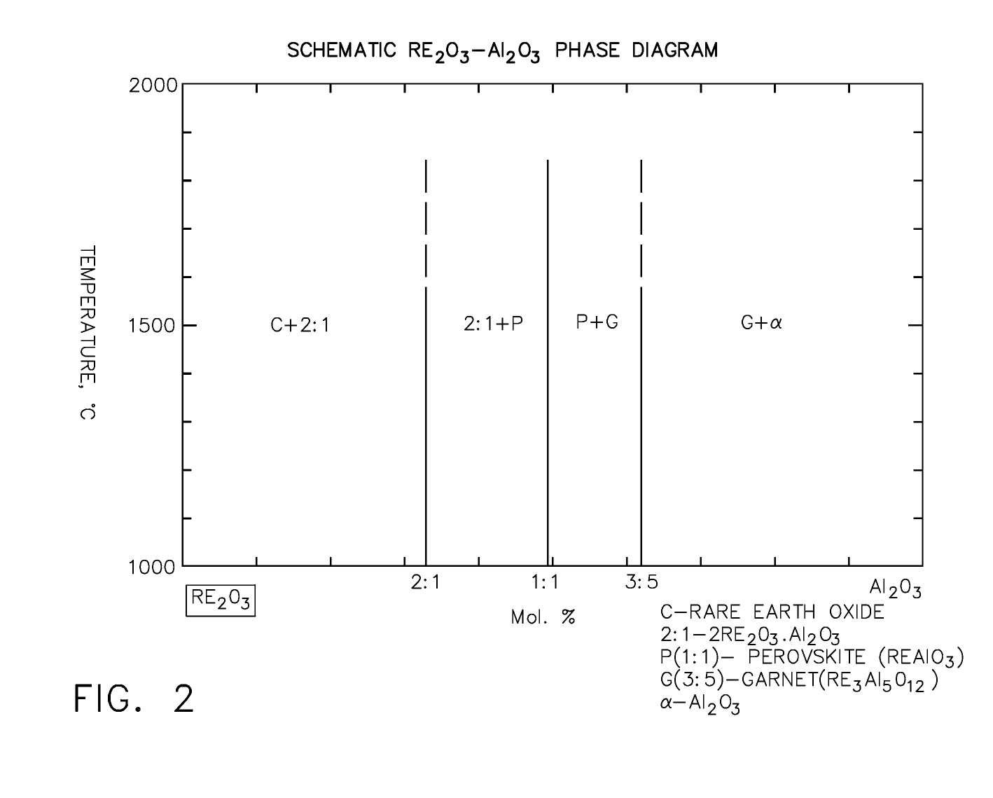

In an exemplary embodiment, TBC top layer 28 comprises a rare earth aluminate-containing material. Exemplary single-phase rare earth aluminate compounds include 2 RE₂O₃.Al₂O₃; REAlO₃; RE₃Al₅O₁₂, where RE=an element of the lanthanum series, yttrium, or combinations thereof. For purposes of the disclosure, the rare earth aluminate-containing material may be regarded as having an aluminum oxide (Al₂O₃) component, and a rare earth oxide component. FIG. 2 provides a schematic Re₂O₃—Al₂O₃ phase diagram illustrating representative rare earth aluminate-containing materials.

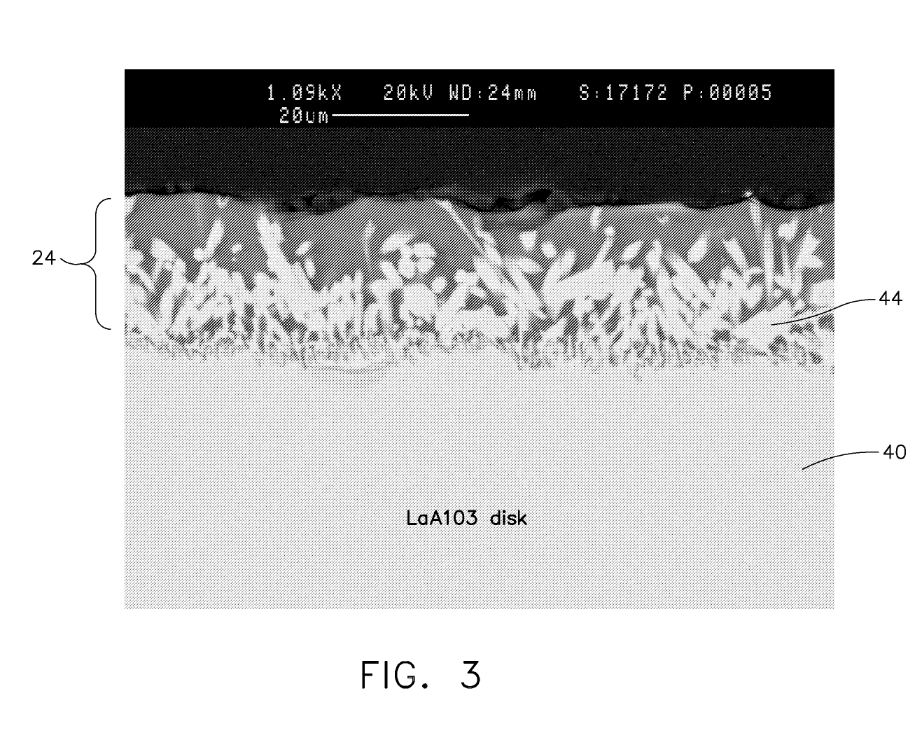

With reference to FIG. 3, upon elevated temperature exposure to CMAS, the aluminum oxide component of the rare earth aluminate containing material 40 interacts with the CMAS to raise the CMAS melting point. The rare earth oxide component reacts with the CMAS to form a sealing reaction layer 42 including a high melting point rare earth calcium silicate phase 44. This sealing reaction layer 42 is effective to protect the underlying TBC layer from CMAS attack at elevated temperatures once the CMAS becomes liquid.

The rare earth aluminate-containing TBC top layer 28 may include a single phase rare earth aluminate compound, a mixture of two or more rare earth aluminate compounds, a rare earth aluminate compound and Al₂O₃, a rare earth aluminate compound and rare earth oxide, where the rare earth is an element of the lanthanum series, yttrium, or combinations thereof.

In an exemplary embodiment, the rare earth aluminate-containing TBC top layer material can have a Al₂O₃ component concentration ranging from about 20 to about 90 mole %, with the remainder including a rare earth oxide, where the rare earth is a lanthanum series element, yttrium, or combinations thereof. Exemplary rare earth aluminate-containing compounds include 2Gd2O3.Al₂O₃, 2Dy₂O₃.Al₂O₃, 2Y₂O₃.Al₂O₃, 2Er₂O₃.Al₂O₃, LaAlO₃, NdAlO₃, SmAlO₃, EuAlO₃, GdAlO₃, DyAlO₃, ErAlO₃., Dy₃Al₅O₁₂, Y₃Al₅O₁₂, Er₃Al₅O₁₂, and Lu₃Al₅O₁₂.

The optional transitional layer 30 may include a stabilized zirconia component (e.g., 7YSZ) and a rare earth aluminate-containing component (e.g., a material similar to TBC top layer 28). If present, the transitional layer 30 is intended to provide a compositional gradient between inner layer 26 and top layer 28. Multiple transitional sub-layers may be provided, with the relative concentrations of the stabilized zirconia component and rare earth aluminate-containing component decreasing and increasing, respectively, in the direction toward the top layer 28. For example the transitional layer 30 may provide a concentration of rare earth aluminate-containing component of about 10 weight % toward a middle region of the coating. Toward the outer surface of the transitional layer, the concentration of the rare earth aluminate-containing component may approach 100 weight %.

With reference again to FIG. 1, an exemplary thermal barrier coating system includes a bond coat layer 16 of about 1 to about 6 mils thick (about 25.4 to about 152 microns); a TBC inner layer 26 of about 1 to about 10 mils thick (about 25.4 to about 254 microns); and a TBC top layer 28 of about 0.5 to about 10 mils thick (about 12.7 to about 254 microns). This exemplary thermal barrier coating system may be useful for providing the desired CMAS resistance for gas turbine engine blades and nozzles, and combustor parts.

Another exemplary thermal barrier coating system includes a bond coat layer 16 of about 2 to about 20 mils thick (about 50.8 to about 508 microns), a TBC inner layer 26 of about 2 to about 25 mils thick (about 50.8 to about 635 microns), and a TBC top layer 28 of from about 10 to about 60 mils thick (about 254 to about 1524 microns). This exemplary thermal barrier coating system may be useful for providing the desired CMAS resistance for gas turbine engine shrouds, and combustor parts. In an exemplary embodiment, the portion of the inner layer 26 particularly susceptible to CMAS degradation is overlaid with the TBC top layer 28.

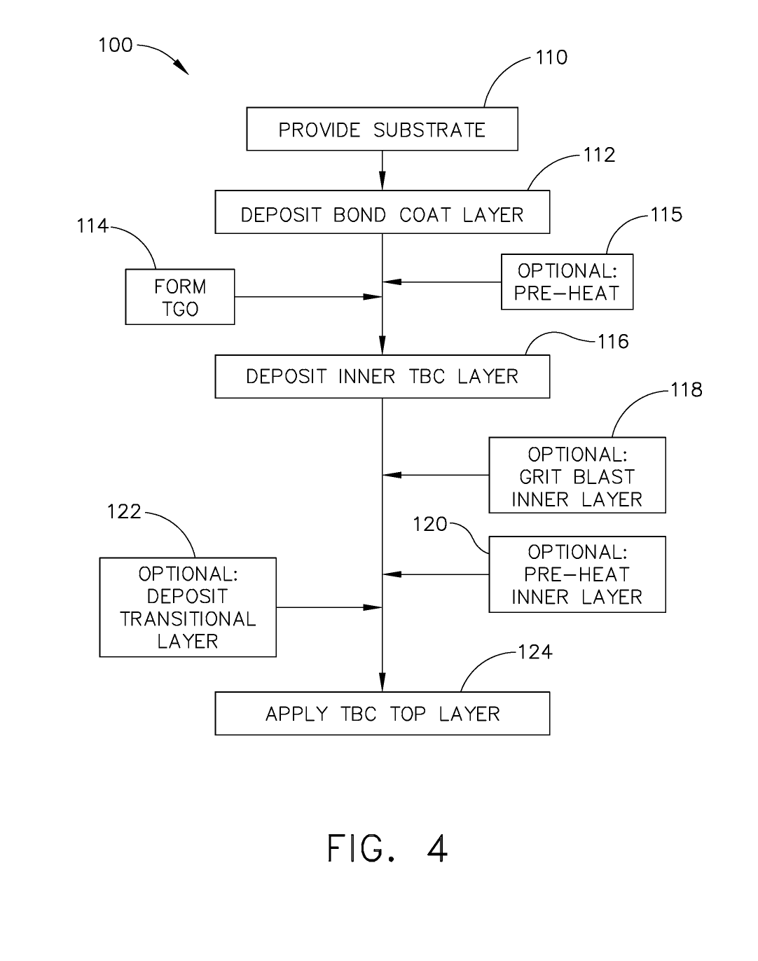

In an exemplary embodiment, a method for increasing resistance to CMAS degradation of a thermal barrier coating system is illustrated in FIG. 4. In an exemplary method 100, a substrate such as a component for a high temperature region of a gas turbine engine is provided (Step 110). A bond coat layer is deposited on at least one surface of the substrate (Step 112). The bond-coated substrate may be subjected to suitable conditions to form a thermally grown oxide layer (Step 114). In an exemplary embodiment, the bond coat layer is substantially overlaid with an inner thermal barrier coating layer (Step 116). The inner thermal barrier coating layer may be deposited by a suitable method such as physical vapor deposition (e.g., electron-beam physical vapor deposition (EB-PVD)) or by thermal spray (e.g., air plasma spray (APS)). The inner thermal barrier coating layer may be deposited in such a manner as to exhibit a microstructure referred to herein as dense vertical microcracks (DVM) as is known in the art. The inner thermal barrier coating layer may exhibit other microstructures depending on the deposition process such as a columnar structure (e.g., from EB-PVD deposition) or a splat-like structure (e.g., from APS). Optionally, the bond-coated substrate may be pre-heated prior to application of the inner thermal barrier coating layer. (Step 115).

In an exemplary method the TBC inner layer may optionally be modified for reception of subsequent TBC layer(s) (Step 118). For example, the surface may be roughened by grit blasting or other surface-modifying techniques. In an exemplary embodiment, the TBC inner layer may optionally be pre-heated prior to deposition of subsequent TBC layer(s) (Step 120).

In an exemplary embodiment, one or more transitional layers may optionally be deposited onto the inner layer (Step 122).

In an exemplary embodiment, a rare earth aluminate-containing material is deposited onto the TBC inner layer (or the optional transitional layer(s)) by a suitable deposition process to form a TBC top layer (Step 124). In an exemplary embodiment, the deposition process may include a physical vapor deposition process. In an exemplary embodiment, the deposition process may include a thermal spray process. Other deposition processes may include liquid spray or liquid reagent infiltration processes. Those with skill in the art will appreciate that various deposition processes may be employed depending on the desired thickness, microstructure, and other thermal or mechanical properties. It is envisioned that the various layers of the TBC system may be deposited by different processes to achieve a desired outcome.

Upon exposure of the coated component to CMAS at elevated temperatures, the melting point of the CMAS is elevated upon contact with the TBC top layer due to dissolution of Al₂O₃ component from the TBC top layer. The elevated melting point deters formation of the highly destructive liquefied CMAS. The rare earth aluminide component from the TBC top layer interacts with the CMAS to form a rare earth calcium silicate phase. The interaction of the CMAS with the TBC top layer effectively forms a sealing reaction layer.

The coating layers disclosed herein may be applied by any suitable method. The method of application may be determined by the component to be coated. Shroud and combustor assemblies require thicker coatings, but are relatively simple shapes. Methods such as thermal spray processes may be used to apply the various layers. Thermal spray processes are inexpensive and relatively quick methods for applying a thick coating to a surface. These techniques generally are line of sight processes. Thermal spray processes include air plasma spray, vacuum plasma spray, low pressure plasma spray, HVOF, detonation gun, and other related methods.

Thinner coatings are required on structures such as blades and vanes. The thinner coatings require more precise controls. Physical vapor depositions are preferred for these applications. Electron beam methods (EB-PVD) are the most preferred method for applying thin coatings to articles such as blades and vanes.

### EXAMPLE

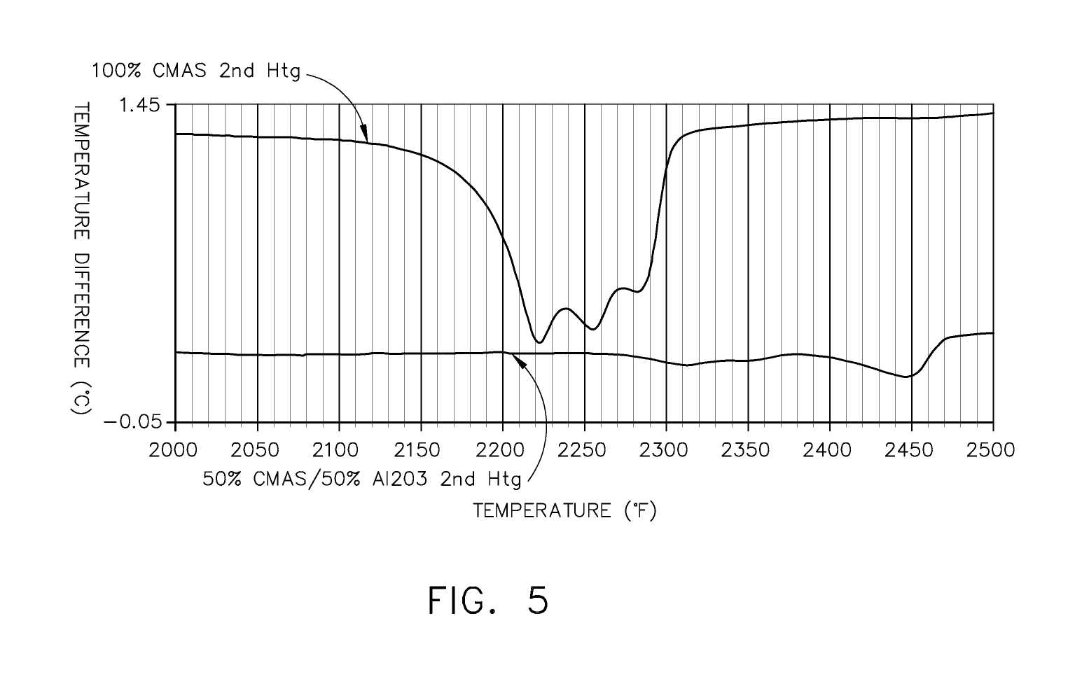

A single phase rare earth aluminate sample (LaAlO₃) was exposed to CMAS at 2500° F. ((1371° C.)) for 1 hour. The micrograph shown in FIG. 2 illustrates the reaction products. LaAlO₃ reacts with CMAS to form a La calcium silicate phase (needle-like shapes). Energy dispersive spectrometer (EDS) analysis showed that the Al₂O₃ content in the post reaction CMAS is much higher than in the original CMAS, an indication of Al₂O₃ component from LaAlO₃ dissolution in the original CMAS. The dissolution of Al₂O₃ in CMAS leads to a CMAS melting point increase, as demonstrated by the CMAS/Al₂O₃ differential thermal analysis (DTA) curves in FIG. 5.

Thus, this example demonstrates that a rare earth aluminate containing TBC top layer provides CMAS protection in the high temperature range by the formation of the sealing reaction layer containing rare earth calcium silicate, and in the low temperature range (where rare earth calcium silicate formation is sluggish) by the CMAS melting point increase due to Al₂O₃ content of the top layer.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. Method for improving resistance to CMAS infiltration of a thermal barrier coating system, the method comprising:
providing a substrate having at least one surface;
providing a bond coat on the substrate surface;
optionally, subjecting the bond coat to suitable conditions to form a thermally grown oxide layer on the bond coat;
depositing an thermal barrier coating inner layer overlying the bond coat, wherein the inner layer includes a thermal barrier coating material including at least one of zirconia and hafnia;
depositing a top layer overlying at least a portion of the inner layer, wherein the top layer includes a rare earth aluminate-containing material.

2. The method according to claim 1 further comprising:
depositing at least one transitional layer subsequent to depositing the inner layer and prior to depositing the top layer.

3. The method according to claim 1 further comprising:
subsequent to depositing the inner layer, modifying a surface of the inner layer in preparation for reception of the top layer.

4. The method according to claim 1 further comprising:
pre-heating the substrate having the bond coat and inner layer deposited thereon to a suitable preheat temperature prior to depositing the top layer.

5. The method according to claim 1 further comprising:
pre-heating the substrate having the bond coat deposited thereon to a suitable preheat temperature prior to depositing the inner layer.

6. The method according to claim 1 wherein depositing the top layer includes depositing at least one of the group consisting of a single phase rare earth aluminate compound, a mixture of two or more rare earth aluminate compounds, a rare earth aluminate compound and aluminum oxide (Al₂O₃), and a rare earth aluminate compound and rare earth oxide.

7. The method according to claim 1 wherein depositing the top layer includes depositing a single phase rare earth aluminate compound selected from the group consisting of 2Gd2O3.Al₂O₃, 2Dy₂O₃.Al₂O₃, 2Y₂O₃.Al₂O₃, 2Er₂O₃.Al₂O₃, LaAlO₃, NdAlO₃, SmAlO₃, EuAlO₃, GdAlO₃, DyAlO₃, ErAlO₃., Dy₃Al₅O₁₂, Y₃Al₅O₁₂, and Lu₃Al₅O₁₂.

8. The method according to claim 1 wherein depositing the top layer includes depositing the rare earth aluminate-containing material comprising from about 20 to about 90 mole % of an aluminum oxide (Al₂O₃) component with a remainder including a rare earth oxide.

9. The method according to claim 1 wherein depositing the inner layer includes depositing at least one member of the group consisting of an at least partially stabilized zirconia composition, an at least partially stabilized hafnia composition, and combinations thereof.

10. The method according to claim 1 further including depositing at least one transitional layer between the inner layer and the top layer, wherein the at least one transitional layer comprises a compositional gradient between the inner layer and the top layer.

11. The method according to claim 1 wherein providing the bond coat includes providing at least one of an MCrAlX overlay coating, a simple aluminide coating, and a platinum modified aluminide coating.

12. The method according to claim 1 wherein:
providing the substrate includes providing a gas turbine engine shroud or combustor part;
providing the bond coat includes providing an MCrAlX overlay coating, a simple aluminide coating, or a platinum modified aluminide coating having a thickness of from about 2 to about 20 mils;
depositing the inner layer includes depositing the thermal barrier coating material to achieve an inner layer thickness of from about 2 to about 25 mils;
depositing the top layer includes depositing the rare earth aluminate-containing material to achieve a top layer thickness of from about 5 to about 60 mils.

13. The method according to claim 1 wherein:
providing the substrate includes providing a gas turbine engine blade, nozzle, or combustor part;
providing the bond coat includes providing an overlay coating, a simple aluminide coating, or a platinum modified aluminide coating having a thickness of from about 1 to about 6 mils;
depositing the inner layer includes depositing the thermal barrier coating material to achieve an inner layer thickness of from about 1 to about 10 mils;
depositing the top layer includes depositing the rare earth aluminate-containing material to achieve a top layer thickness of from about 0.5 to about 10 mils.

14. The method according to claim 1 wherein depositing the inner layer includes utilizing a deposition technique selected from thermal spray processes, physical vapor deposition processes, chemical deposition processes, and slurry deposition processes.

15. The method according to claim 1 wherein depositing the top layer includes utilizing a deposition technique selected from thermal spray processes, physical vapor deposition processes, chemical deposition processes, and slurry deposition processes.

16. Method for improving resistance to CMAS infiltration of a thermal barrier coating system, the method comprising:
depositing an thermal barrier coating inner layer onto a bond coated substrate for use in a hot section of a gas turbine engine;
depositing a top layer overlying at least a portion of the inner layer, wherein the top layer includes a rare earth aluminate-containing material.

17. The method according to claim 16 wherein the rare earth aluminate-containing material is at least one member selected from a single phase rare earth aluminate compound, a mixture of two or more rare earth aluminate compounds, a rare earth aluminate compound and aluminum oxide (Al₂O₃), and a rare earth aluminate compound and rare earth oxide.

18. The method according to claim 17 wherein the single phase rare earth aluminate compound is selected from the group consisting of 2Gd2O3.Al₂O₃, 2Dy₂O₃.Al₂O₃, 2Y₂O₃.Al₂O₃, 2Er₂O₃.Al₂O₃, LaAlO₃, NdAlO₃, SmAlO₃, EuAlO₃, GdAlO₃, DyAlO₃, ErAlO₃., Dy₃Al₅O₁₂, Y₃Al₅O₁₂, Er₃Al₅O₁₂, and Lu₃Al₅O₁₂.

19. The method according to claim 17 wherein the rare earth aluminate-containing material comprises from about 20 to about 90 mole % of an aluminum oxide (Al₂O₃) component with a remainder including a rare earth oxide.
